(19) United States
(12) Patent Application Publication
(10) Pub. No.: US 2026/0245388 A1
(43) Pub. Date: Aug. 20, 2026

(54) TRAINING-FREE VEHICLE RE-IDENTIFICATION METHOD BASED ON VISION-LANGUAGE LARGE MODEL

(71) Applicant: Central China Normal University, Wuhan (CN)

(72) Inventors: xu Chen, Wuhan (CN); Di Wu, Wuhan (CN)

(21) Appl. No.: 19/411,563

(22) Filed: Dec. 8, 2025

(30) Foreign Application Priority Data
Feb. 19, 2025 (CN) 2025101853387

(51) Int. Cl. G06V 20/70; G06T 3/40; G06T 5/50; G06T 7/00; G06T 7/11; G06V 10/74; G06V 10/77

(52) U.S. Cl. CPC G06V 20/70; G06T 3/40; G06T 5/50; G06T 7/0002; G06T 7/11; G06V 10/761; G06V 10/7715; G06T 2207/20221

(57) ABSTRACT

A training-free vehicle re-identification method based on a vision-language large model includes: performing dynamic multi-granularity text generation, including: utilizing the vision-language large model to perform visual feature analysis on vehicles to thereby generate structured hierarchical descriptions; constructing a hierarchical generation framework to hierarchically generate basic semantic labels for a vehicle type, a vehicle color, and visible viewpoints, and detail descriptions of target regions guided by local semantics; and dynamically adjusting a hierarchy of the structured hierarchical descriptions based on confidence; performing adaptive feature fusion for realizing adaptive fusion of visual-textual features for coarse vehicle similarity ranking, including: image quality-guided visual feature weight calculation, semantic confidence-driven textual feature weight allocation, and visual-textual fusion coarse ranking; and performing combinatorial contrastive reasoning to divide Top-N images from a visual-textual coarse ranking list into multiple contrast groups and utilize the vision-language large model for multi-image joint analysis to achieve fine-ranking.

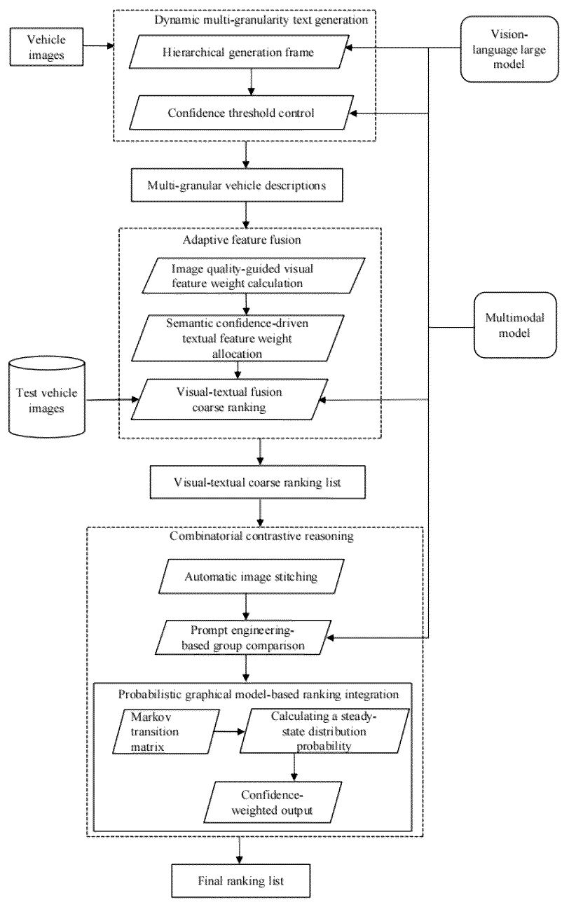

### CROSS-REFERENCE TO RELATED APPLICATION

the present disclosure claims the priority of Chinese Patent Application No. 202510185338.7, filed on Feb. 19, 2025, which is herein incorporated by reference in its entirety.

### TECHNICAL FIELD

The present disclosure relates to the technical field of computer vision and intelligent transportation, and particularly to a training-free vehicle re-identification method based on a vision-language large model.

### BACKGROUND

Vehicle re-identification refers to determining an identity of a vehicle based on appearance characteristics of the vehicle and is an important means to compensate for the limitations of recognition verification of a license plate of the vehicle. Existing vehicle re-identification methods mainly have the following limitations: reliance on supervised training, where existing methods require large amounts of annotated data for model training, making it difficult to adapt to new scenarios; and single-modal limitations, where using only visual features is easily interfered with by factors such as lighting changes and viewpoint differences. Existing vision-language large models can effectively generate image descriptions. Therefore, there is an urgent need to explore a training-free vehicle re-identification method based on a vision-language large model.

### SUMMARY

Aiming at the above problems in the related art, the present disclosure proposes a training-free vehicle re-identification method based on a vision-language large model, which effectively improves the robustness and generalization ability of vehicle re-identification.

To achieve the above objectives, technical solutions adopted in the present disclosure are as follows.

In an embodiment, a training-free vehicle re-identification method based on a vision-language large model is provided, which includes:
step 1, performing dynamic multi-granularity text generation, including: utilizing the vision-language large model to perform visual feature analysis on vehicles to thereby generate structured hierarchical descriptions; constructing a hierarchical generation framework to hierarchically generate basic semantic labels for a vehicle type, a vehicle color, and visible viewpoints, and detail descriptions of target regions guided by local semantics; and dynamically adjusting a hierarchy of the structured hierarchical descriptions based on confidence;
step 2, performing adaptive feature fusion for realizing adaptive fusion of visual-textual features for coarse vehicle similarity ranking, including: image quality-guided visual feature weight calculation, semantic confidence-driven textual feature weight allocation, and visual-textual fusion coarse ranking; and
step 3, performing combinatorial contrastive reasoning to divide Top-N images from a visual-textual coarse ranking list into multiple contrast groups and utilize the vision-language large model to perform multi-image joint analysis to achieve fine-ranking, including: automatic image stitching, prompt engineering-based group comparison, and probabilistic graphical model-based ranking integration.

In an embodiment, in the step 1, the performing dynamic multi-granularity text generation further includes: the following steps 1-1 and 1-2.

In the step 1-1, the hierarchical generation framework is constructed, a first level of the hierarchical generation framework is configured to generate basic descriptions of the vehicle type, the vehicle color, and the visible viewpoints (a front viewpoint, a rear viewpoint, a side viewpoint, a front-side viewpoint, and a rear-side viewpoint), a second level of the hierarchical generation framework is configured to generate detailed descriptions of a vehicle roof area, and a third level of the hierarchical generation framework is configured to guide the vision-language large model to focus on the target regions based on the visible viewpoints to generate the detailed descriptions of the target regions, such as descriptions of vehicle windows, a vehicle grille, vehicle lights, and a vehicle logo for the front viewpoint.

In the step 1-2, confidence threshold control is performed, which includes: utilizing a multimodal model such as a Contrastive Language-Image Pre-Training (CLIP) model as a feature detector, in response to a local feature detection confidence C_d being smaller than a preset weight, masking a corresponding detailed description, and in response to a global feature matching degree C_t being smaller than a preset re-detection weight, triggering a re-detection process.

In an embodiment, in the step 2, the performing adaptive feature fusion includes:
step 2-1, performing the image quality-guided visual feature weight calculation, including:
   based on a Tenengrad function and an entropy function, calculating a clarity score Q_v of each image of the multiple contrast groups, Q_v∈[0, 1]; and calculating an image quality-guided visual feature weight according to the clarity score of the image;
   step 2-2, performing the semantic confidence-driven textual feature weight allocation, including: calculating a semantic confidence-driven textual feature weight according to a local feature detection confidence C_d and a global feature matching degree C._t; and
step 2-3, performing the visual-textual fusion coarse ranking, including:
   normalizing the image quality-guided visual feature weight and the semantic confidence-driven textual feature weight;
   using a multimodal model supporting a long text to extract image features of all query vehicle images and all test vehicle images;
   based on the image features of all query vehicle images and all test vehicle images and multi-level textual features generated using the hierarchical generation framework, calculating visual similarities S_v between all query vehicle images and all test vehicle images, and textual similarities at different levels (S_t, S_r, S_d);
   performing a weighted sum of the visual similarities and the textual similarities based on the image quality-guided visual feature weight and the semantic confidence-driven textual feature weight, to obtain a final similarity; and
   obtaining, based on the final similarity, the visual-textual coarse ranking list for all query vehicle images.

In an embodiment, in the step 3, the combinatorial contrastive reasoning further includes:
step 3-1, performing the automatic image stitching, including:
   constructing a four-image stitching template “[Query Image] [Candidate Image A] [Candidate Image B] [Candidate Image C]”;
   scaling input images to a uniform size of 224× 224 to obtain scaled input images;
   stitching the scaled input images vertically; and
   adding learnable spatial position encodings at stitching boundaries;
step 3-2, performing the prompt engineering-based group comparison, including:
   constructing a structured prompt template: “as a vehicle identification expert, please determine a similarity based on the following dimensions: a vehicle type contour matching degree with a weight of 40%, a color spectral consistency with a weight of 30%, and a detail feature consistency, including a vehicle sunroof, a vehicle logo, a vehicle grille, and vehicle windows with a weight of 30%; and an output format of the similarity is as follows: best match identifier (ID)>second best match ID>least match ID”; and
   establishing an abnormal response filtering mechanism, where the abnormal response filtering mechanism is configured to: when an output result outputted by a model does not conform to a preset format, automatically discard the output result; and
step 3-3, performing the probabilistic graphical model-based ranking integration, including:
   establishing a Markov transition matrix among first N images in the visual-textual coarse ranking list, N is in a range of 50 to 100;
   calculating a steady-state distribution probability by using a random walk algorithm; and
   performing confidence-weighted output to form a final ranking list.

In an embodiment, the training-free vehicle re-identification method based on the vision-language large model is implemented by a computing system, which includes a processor and a memory storing computer instructions executable by the processor. The training-free vehicle re-identification method based on the vision-language large model further includes: identifying a top-ranked vehicle in the final ranking list as the target vehicle; retrieving, from a database, records of the target vehicle captured by multiple cameras; constructing a chronological trajectory sequence of the target vehicle; and generating a vehicle trajectory report for use in criminal investigation, traffic control, or real-time operations.

Compared with the related art, beneficial effects of the training-free vehicle re-identification method based on the vision-language large model of the present disclosure are as follows.

1. The method of the present disclosure breaks through the dependence of traditional vehicle re-identification on closed-scenario data, and can be directly applied to open environments across cities and cameras without fine-tuning, significantly reducing model tuning costs.

2. The method of the present disclosure constructs a dynamic multi-granularity text generation module, which is used for generating multi-granularity semantic descriptions including global vehicle attributes (type, and color) and local details (logo, decorations, and damage), and is capable of supporting both “text-to-image” and “image-to-text” bidirectional queries.

### BRIEF DESCRIPTION OF DRAWING

FIGURE illustrates a schematic flowchart of a training-free vehicle re-identification method based on a vision-language large model according to an embodiment of the present disclosure.

### DETAILED DESCRIPTION OF EMBODIMENTS

The present disclosure is described in detail below in conjunction with an accompanying drawing and specific embodiments.

As shown in FIGURE, a training-free vehicle re-identification method based on a vision-language large model provided by an embodiment of the present disclosure includes the following steps 1 to 3.

In the step 1, dynamic multi-granularity text generation is performed, which includes: utilizing the vision-language large model to perform visual feature analysis on vehicles to thereby generate structured hierarchical descriptions; constructing a hierarchical generation framework to hierarchically generate basic semantic labels for a vehicle type, a vehicle color, and visible viewpoints, and detail descriptions of target regions guided by local semantics; and dynamically adjusting a hierarchy of the structured hierarchical descriptions based on confidence.

In the step 2, adaptive feature fusion is performed for realizing adaptive fusion of visual-textual features for coarse vehicle similarity ranking, which includes: image quality-guided visual feature weight calculation, semantic confidence-driven textual feature weight allocation, and visual-textual fusion coarse ranking.

In the step 3, combinatorial contrastive reasoning is performed to divide Top-N images from a visual-textual coarse ranking list into multiple contrast groups and utilize the vision-language large model to perform multi-image joint analysis to achieve fine-ranking, which includes: automatic image stitching, prompt engineering-based group comparison, and probabilistic graphical model-based ranking integration.

Next, the method is explained in detail.

In an embodiment, specifically, the step 1 includes the following steps 1-1 and 1-2.

In the step 1-1, the hierarchical generation framework is constructed, specifically, a first level of the hierarchical generation framework is configured to generate basic descriptions of the vehicle type, the vehicle color, and the visible viewpoints (a front viewpoint, a rear viewpoint, a side viewpoint, a front-side viewpoint, and a rear-side viewpoint), a second level of the hierarchical generation framework is configured to generate detailed descriptions of a vehicle roof area, and a third level of the hierarchical generation framework is configured to guide the vision-language large model to focus on the target regions based on the visible viewpoints to generate the detailed descriptions of the target regions, such as descriptions of vehicle windows, a vehicle grille, vehicle lights, and a vehicle logo for the front viewpoint.

In the step 1-2, confidence threshold control is performed, which includes: utilizing a multimodal model such as a Contrastive Language-Image Pre-Training (CLIP) model as a feature detector, in response to a local feature detection confidence C_d being smaller than a preset threshold, masking a corresponding detailed description, and in response to a global feature matching degree C._t being smaller than a preset re-detection threshold, triggering a re-detection process.

In an embodiment, specifically, the step 2 includes the following steps 2-1, 2-2, and 2-3.

In the step 2-1, the image quality-guided visual feature weight calculation is performed, which includes: based on a Tenengrad function and an entropy function, calculating a clarity score of each image Q_v, Q_v∈[0,1], and calculating an image quality-guided visual feature weight a based on the clarity score of the image Q_v according to a formula 1 expressed as follows:

$$α = sigmoid ( Q\_v \times 0.5 ) \times 0.7 . \qquad ( Formula 1 )$$

In the step 2-2, the semantic confidence-driven textual feature weight allocation is performed, which includes: calculating a semantic confidence-driven textual feature weight β according to a formula 2 expressed as follows:

$$β = 0.25 \times C\_t + 1 \text{.0} \times C\_d . \qquad ( Formula 2 )$$

In the step 2-3, the visual-textual fusion coarse ranking is performed, which includes: normalizing the image quality-guided visual feature weight α and the semantic confidence-driven textual feature weight β according to a formula 3 expressed as follows:

$${α}^{′} = \frac{α}{α + β} , {β}^{′} = \frac{β}{α + β} . \qquad ( Formula 3 )$$

Specifically, the visual-textual fusion coarse ranking further includes: using a multimodal model that supports long text (i.e., a text with a length greater than 77 tokens), such as Long-Caption Language-Image Pre-training (Long CLIP) to extract image features of all query vehicle images and all test vehicle images; based on the image features of all query vehicle images and all test vehicle images and multi-level textual features generated using the hierarchical generation framework, calculating visual similarities S_v between all query vehicle images and all test vehicle images, and textual similarities at different levels (S_t, S_r, S_d); and calculating a final similarity according to a formula 4 expressed as follows:

$$S = S\_v \times {α}^{′} + ( S\_t \times \frac{0.25 \times C\_t}{0.25 \times C\_t + 1. \times C\_d} + S\_r \times \frac{0.05 \times C\_d}{0.25 \times C\_t + 1 \text{.0} \times C\_d} + S\_d \times \frac{0.05 \times C\_d}{0.25 \times C\_t + 1 \text{.0} \times C\_d} ) \times {β}^{′} . \qquad ( Formula 4 )$$

Based on the final similarity, the visual-textual coarse ranking list for all query vehicle images is obtained.

In an embodiment, specifically, the step 3 includes the following steps 3-1, 3-2, and 3-3.

In the step 3-1, the automatic image stitching is performed, which includes: constructing a four-image stitching template “[Query Image] [Candidate Image A] [Candidate Image B] [Candidate Image C]”, scaling input images to a uniform size of 224×224 to obtain scaled input images and then stitching the scaled input images vertically, adding learnable spatial position encodings at stitching boundaries.

In the step 3-2, the prompt engineering-based group comparison is performed, which includes: constructing a structured prompt template: “as a vehicle identification expert, please determine a similarity based on the following dimensions: 1. a vehicle type contour matching degree (a weight of 40%), 2. a color spectral consistency (a weight of 30%), and 3. a detail feature consistency, such as a vehicle sunroof, a vehicle logo, a vehicle grille, and vehicle windows (a weight of 30%), and an output format of the similarity is as follows: best match ID>second best match ID>least match ID”, and establishing an abnormal response filtering mechanism, where the abnormal response filtering mechanism is configured to: when an output result outputted by a model does not conform to a preset format, automatically discard the output result.

In the step 3-3, the probabilistic graphical model-based ranking integration is performed, which includes: establishing a Markov transition matrix among the Top-N (generally between 50 and 100) images in the visual-textual coarse ranking list, calculating a steady-state distribution probability by using a random walk algorithm, and performing confidence-weighted output to form a final ranking list.

In an embodiment, specifically, the step 3-3 includes the following steps 3-3-1, 3-3-2, 3-3-3.

In the step 3-3-1, the Markov transition matrix is established, which includes:
defining a state space;
taking a set of first N images G={g₁, g₂, . . . , g_{N}} from the visual-textual coarse ranking list as state nodes of a Markov chain, where each state sᵢ corresponds to an image gᵢ;
performing similarity score conversion based on the similarity outputted in the step 3-2;
numerically processing each group of contrastive reasoning result groups (e.g., “g₁>g₂>g₃”);
assigning score 1=1.0 to an image ranked first, assigning score 2=0.7 to an image ranked second, and assigning score 3=0.4 to an image ranked third;
standardizing scores of each group of the contrastive reasoning result groups according to a formula 5 expressed as follows:

$${p}_{i \vert j , k} = \frac{exp ( {score}_{i} )}{{\sum }_{m ∈ \{ j , k \}} exp ( {score}_{m} )} \qquad ( Formula 5 )$$

where j and k represent other images in the N/2 contrast groups; and
calculating a transition probability, and constructing a state transition matrix T∈R^{N×N}, where an element Tᵢⱼ in the state transition matrix represents a probability of transitioning from the state sᵢ to sⱼ, and a calculation formula of the element Tᵢⱼ is a formula 6 expressed as follows:

$${T}_{i j} = \frac{{\sum }_{k \neq i , j} ( {p}_{j \vert i , k} + {p}_{j \vert k , i} )}{2 ( N - 2 )} , \qquad ( Formula 6 )$$

where a diagonal element Tᵢᵢ in the state transition matrix is set to a self-loop probability ϵ (e.g., 0.05) to ensure ergodicity of the Markov chain.

In the step, 3-3-2, the steady-state distribution probability is calculated by using the random walk algorithm, which includes: initializing a probability

$${{π}^{( 0 )} = [ \frac{1}{N} , \frac{1}{N} , … , \frac{1}{N} ]}^{T} ,$$

and performing damped random walk iteration with a damping coefficient d (e.g., 0.85), to thereby perform iterative updates according to a formula 7 expressed as follows to thus obtain a final steady-state probability π*, where the final steady-state probability π* represents a similarity of all test vehicle images:

$${π}^{( t + 1 )} = d \cdot {T}^{T} {π}^{( t )} + ( 1 - d ) \cdot {π}^{0} . \qquad ( Formula 7 )$$

In the step 3-3-3, the confidence-weighted output is performed, which includes: performing, according to a formula 8 expressed as follows, weighted calculation based on a number of times Cᵢ an image appears in the contrast groups to obtain a weighted similarity, as a final similarity to thereby obtain the final ranking list:

$${S}_{i} = {π}_{i} \times log ( 1 + {C}_{i} ) . \qquad ( Formula 8 )$$

Contents not described in detail in this specification belong to the prior art known to those skilled in the art.

Although the present disclosure has been described in detail above and examples have been provided, the present disclosure and applicable embodiments are not limited thereto. Those skilled in the art can make various modifications based on the principles of the present disclosure, and can also apply parts of the methods of the present disclosure to other systems. Therefore, all modifications made according to the principles of the present disclosure should be understood as falling within the protection scope of the present disclosure.

1. A training-free vehicle re-identification method based on a vision-language large model, comprising:
step 1, performing dynamic multi-granularity text generation, comprising: utilizing the vision-language large model to perform visual feature analysis on vehicles to thereby generate structured hierarchical descriptions; constructing a hierarchical generation framework to hierarchically generate basic semantic labels for a vehicle type, a vehicle color, and visible viewpoints, and detail descriptions of target regions guided by local semantics; and dynamically adjusting a hierarchy of the structured hierarchical descriptions based on confidence;
wherein in the step 1, the performing dynamic multi-granularity text generation specifically comprises:
step 1-1, constructing the hierarchical generation framework, comprising:
configuring a first level of the hierarchical generation framework to generate basic descriptions of the vehicle type, the vehicle color, and the visible viewpoints, wherein the visible viewpoints comprise: a front viewpoint, a rear viewpoint, a side viewpoint, a front-side viewpoint, and a rear-side viewpoint;
configuring a second level of the hierarchical generation framework to generate detailed descriptions of a vehicle roof area; and
configuring a third level of the hierarchical generation framework to guide the vision-language large model to focus on the target regions based on the visible viewpoints to generate the detailed descriptions of the target regions; and
step 1-2, performing confidence threshold control, comprising:
utilizing a multimodal model as a feature detector;
in response to a local feature detection confidence C_d being smaller than 0.6, masking corresponding detailed description; and
in response to a global feature matching degree C. t being smaller than 0.4, triggering a re-detection process;
step 2, performing adaptive feature fusion for realizing adaptive fusion of visual-textual features for coarse vehicle similarity ranking, comprising: image quality-guided visual feature weight calculation, semantic confidence-driven textual feature weight allocation, and visual-textual fusion coarse ranking;
wherein in the step 2, the performing adaptive feature fusion specifically comprises:
step 2-1, performing the image quality-guided visual feature weight calculation, comprising:
based on a Tenengrad function and an entropy function, calculating a clarity score of each image Q_v, Q_V∈[0, 1]; and
calculating an image quality-guided visual feature weight according to the clarity score of the image;
step 2-2, performing the semantic confidence-driven textual feature weight allocation, comprising: calculating a semantic confidence-driven textual feature weight according to a local feature detection confidence C_d and a global feature matching degree C. t; and
step 2-3, performing the visual-textual fusion coarse ranking, comprising:
normalizing the image quality-guided visual feature weight and the semantic confidence-driven textual feature weight;
using a multimodal model supporting a long text to extract image features of all query vehicle images and all test vehicle images;
based on the image features of all query vehicle images and all test vehicle images and multi-level textual features generated using the hierarchical generation framework, calculating visual similarities S_v between all query vehicle images and all test vehicle images, and textual similarities at different levels (S_t, S_r, S_d);
performing a weighted sum of the visual similarities and the textual similarities based on the image quality-guided visual feature weight and the semantic confidence-driven textual feature weight, to obtain a final similarity; and
obtaining, based on the final similarity, the visual-textual coarse ranking list for all query vehicle images; and
step 3, performing combinatorial contrastive reasoning to divide Top-N images from a visual-textual coarse ranking list into N/2 contrast groups and utilize the vision-language large model to perform multi-image joint analysis to achieve fine-ranking, comprising: automatic image stitching, prompt engineering-based group comparison, and probabilistic graphical model-based ranking integration;
wherein in the step 3, the combinatorial contrastive reasoning specifically comprises:
step 3-1, performing the automatic image stitching, comprising:
constructing a four-image stitching template “[Query Image] [Candidate Image A] [Candidate Image B] [Candidate Image C]”;
scaling input images to a uniform size of 224×224 to obtain scaled input images;
stitching the scaled input images vertically; and
adding learnable spatial position encodings at stitching boundaries;
step 3-2, performing the prompt engineering-based group comparison, comprising:
constructing a structured prompt template: “as a vehicle identification expert, please determine a similarity based on the following dimensions: a vehicle type contour matching degree with a weight of 40%, a color spectral consistency with a weight of 30%, and a detail feature consistency, comprising a vehicle sunroof, a vehicle logo, a vehicle grille, and vehicle windows with a weight of 30%; and an output format of the similarity is as follows: best match identifier (ID)>second best match ID>least match ID”; and
establishing an abnormal response filtering mechanism, where the abnormal response filtering mechanism is configured to: when an output result outputted by the vision-language large model does not conform to a preset format, automatically discard the output result; and
step 3-3, performing the probabilistic graphical model-based ranking integration, comprising:
establishing a Markov transition matrix among first N images in the visual-textual coarse ranking list, wherein N is an integer in a range of 50 to 100;
calculating a steady-state distribution probability by using a random walk algorithm; and
performing confidence-weighted output to form a final ranking list;
wherein in the step 3-3, the the performing the probabilistic graphical model-based ranking integration further comprises:
step 3-3-1, establishing the Markov transition matrix, comprising:
defining a state space;
taking a set of the first N images G={g₁, g₂, . . . g_{N}} from the visual-textual coarse ranking list as state nodes of a Markov chain, where each state sᵢ corresponds to an image gᵢ;
performing similarity score conversion based on the similarity outputted in the step 3-2;
numerically processing each group of contrastive reasoning result groups;
standardizing scores of each group of the contrastive reasoning result groups to obtain standardized scores;
calculating a transition probability based on the standardized scores; and
constructing a state transition matrix T∈R^{N×N}, where a diagonal element T in the state transition matrix is set to a self-loop probability €=0.05 to ensure ergodicity of the Markov chain;
step 3-3-2, calculating the steady-state distribution probability by using the random walk algorithm, comprising:
initializing a probability distribution
$${π}^{( 0 )} = {[ \frac{1}{N} , \frac{1}{N} , … , \frac{1}{N} ]}^{T} ;$$
and
performing damped random walk iteration with a damping coefficient d=0.85, to thereby perform iterative updates to thus obtain a final steady-state probability π*, where the final steady-state probability π* represents a similarity of all test vehicle images; and
step 3-3-3, performing the confidence-weighted output, comprising:
performing weighted calculation based on a number of times Cᵢ an image appears in the contrast groups to obtain a weighted similarity, as a final similarity to thereby obtain the final ranking list.

2-5. (canceled)
